(19) United States
(12) Patent Application Publication
(10) Pub. No.: US 2005/0137932 A1
(43) Pub. Date: Jun. 23, 2005

(54) System and method of enterprise risk evaluation and planning

(76) Inventors: Joseph Karl D'Angelo, Marlton, NJ (US); Joseph David Lakitsky, Downing Town, PA (US); David Kenneth Woodard, Ijamsville, MD (US); Wei-San L. O'Bryne, Sunnyvale, CA (US); Bradley Bernard Myers, Orlando, FL (US); Lisa M. Wild, Denver, CO (US)

Correspondence Address: WELSH & KATZ, LTD, 120 S RIVERSIDE PLAZA, 22ND FLOOR, CHICAGO, IL, 60606, US

(21) Appl. No.: 10/745,231

(22) Filed: Dec. 23, 2003

(51) Int. Cl. G06F 17/60

(52) U.S. Cl. 705/10

(57) ABSTRACT

A system and method support strategic decision making for an enterprise. Status of various aspects of the enterprise can be evaluated. Alternately, feedback can be provided as to the consequences of various courses of action.

### FIELD OF THE INVENTION

The invention pertains to systems and methods of evaluating enterprise risks. More particularly, the invention pertains to such systems and methods which provide feedback as to risk associable with a set of properties relied on or used by the enterprise.

### BACKGROUND

Today's enterprises, be they non-profit organizations such as government agencies or non-profit foundations or profit oriented businesses face a variety of challenges in dealing with a global economy, speed of technology advancement and obsolescence and ongoing political/economic trends. The ability to manage the architecture of the enterprise adds to the possibility of substantially contributing to the ongoing success of the enterprise's day to day, as well as long term activities. However, it has also been recognized that assessing and modifying enterprise architecture can be an arduous activity given large numbers of interrelated assets which may be geographically dispersed and which do not always operate with the same agenda. Enterprise management, particularly at the upper levels of the enterprise, is often interested in strategic considerations and evaluating risk associated with various aspects of enterprise activities.

One approach to enterprise modification and redesign has been described by Vogel et al., Re-engineering with Enterprise Analyzer, Proceedings of the 26^{th} Hawaii International Conference on System Sciences, Vol. 4, IEEE, pgs. 127-136, January 1993. Another approach has been described by Rood in “Enterprise Architecture: Definition, Content and Utility”, IEEE July, 1994, pp. 106-111.

Despite developments in this area, despite the availability of relational databases which can bring together large amounts of information about enterprises, such as disclosed in U.S. Pat. No. 6,442,557, there continues to be a need for improved tools that management can use to assess a variety of aspects associated with the enterprise. Preferably, such capabilities would go beyond just returning basic information from a relational database in response to queries. Preferably, such tools would offer insight to management as to where and what kinds of risks the organization might face relative to its reliance on, changes in or to, or, use of a selectable set of properties. The properties of interest to an enterprise vary greatly depending on the nature and scope of the enterprise. Preferably such tools would be flexible enough to enable management to have extensive databases built and then information extracted therefrom and processed relative to arbitrary sets of properties that might be of interest to the enterprise.

### SUMMARY OF THE INVENTION

Enterprise evaluation software includes first software that evaluates enterprise assets in accordance with a first set of criteria. Second software can be used to evaluate those assets in accordance with a second set of criteria. The software can be recorded on a computer readable medium.

The first software can classify the evaluation results in accordance with a first multi-level rating system. The second software can classify the evaluation results in accordance with a second multi-level rating system. In one aspect, the rating systems can provide information as to risks associated with relying on, modifying, or using the assets.

A system whicih includes the software accepts a specification of a set of assets of interest. The set of assets can then be evaluated by the software. The results of the evaluation can be presented to a user for consideration in the context of multi-level risk ratings.

### BRIEF DESCRIPTION OF THE DRAWINGS

FIG. 1 is a block diagram of a hardware/software system in accordance with the invention;

FIG. 2 is a flow diagram of a method in accordance with the invention;

FIG. 3 is a schematic diagram of a data structure useable in the system of FIG. 1;

FIG. 4 illustrates details of some of the method steps of FIG. 2;

FIGS. 5A, B together disclose additional details of the method steps of FIG. 4;

FIG. 6 illustrates some of the details of other method steps of FIG. 4;

FIGS. 7A, B together disclose additional details of the method steps of FIG. 6;

FIG. 8 is a graphical screen presentation of exemplary results of carrying out the method steps of FIG. 2;

FIG. 9 is a screen useable to update risk assessment information for a selected property;

FIG. 10 illustrates additional data elements of the database of FIG. 2;

FIG. 11 is a graphical screen presentation of an exemplary over-all risk reduction/modernization plan;

FIG. 12 is a screen useable to develop a risk reduction/modernization plan for a selected property;

FIG. 13 is a page of a sample report by functional area within an organization or business;

FIG. 14 is a page of a sample report of criticality information relative to the respective property(s);

FIG. 15 is a page of a sample report of a selected property within a functional area; and

FIG. 16 is a page of a report reflecting all information for a property in the portfolio.

### DESCRIPTION OF THE PREFERRED EMBODIMENTS

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

Systems and methods that embody the invention assist an enterprise such as an organization or business in evaluating or assessing the risk associated with selected properties that the organization or business relies on or uses in carrying out its normal operations. For example, the properties could be computer program applications. Other types of properties could include, without limitation, land or water vehicles, aircraft or real estate.

A selected set of such properties can be evaluated from the point of view of a first set of predetermined criteria. For example the “health” or operating condition and effect of the various members of the set can be evaluated in accordance with the first criteria.

Additionally, the properties can also be evaluated from the point of view of second set of predetermined criteria. For example, where the properties correspond to the computer programs, factors such as the “viability” of the technologies upon which the properties, or programs, are dependent can be evaluated in accordance with the second criteria to develop a quantitative measure of the risk the organization has in being dependent on the selected set of properties.

Disclosed systems and methods then assist management to position the business to make a conscious decision of which “risks” need to be mitigated versus which “risks” the organization, or, business will continue to accept in the context of a modernization plan.

In another aspect, systems and methods in accordance with the invention support a database, for example a relational data base, which includes information about each of the selected properties the business is dependent upon. For example, where the properties correspond to computer programs, such as various applications the business relies on, the database can include related data such as supported business functions, business ownership, business utilization, cost, sizing, architecture, software, hardware, operating system, database management system, security, computer languages, application linkages, and employed commercial packages.

Given the wide array of captured information, there is a wide range of questions or needs that can be responded to through the data stored within the relational database. These questions include but are not be limited to: questions associated with divestitures and acquisitions, property or application “change” impact analysis, and vendor/tool utilization, vulnerability of selected properties to adverse consequences or consequences associated with economic trends.

It will be understood that the types of property selected are not a limitation of the invention. The system database would incorporate the type of data that is appropriate for the respective type of property. It will also be understood that the present systems and methods are applicable to all types of organizations or businesses without limitation.

Initially, the database is populated with basic information about each of the types of properties, for examples, computer programs, or applications, that the organization or business relies, or is dependent upon. Once populated, the database can support a wide variety of queries to assist the organization or business in answering questions and making decisions. Where the set of properties corresponds to computer programs, sample queries can include, without limitation: how many programs, or, applications are dependent upon a specified database management system, which applications are used by company x which has just been divested from the corporation, what solutions are other business units within the corporation using to handle accounts payable?

In a disclosed embodiment where the properties are computer programs, the assessment process then begins with program, or application “Health” Check and Technical Maturity evaluations. The elements and criteria against which these evaluations are performed are predetermined and can be varied with experience and the particular properties. The evaluation results are stored in the database.

Subsequently in the assessment process is an Analysis, Prioritization, & Modernization Planning process. Within this process the risks identified through the prior “Health Check and Technical Maturity evaluations are combined automatically or by management along with business goals and affordability to determine a Modernization Plan for each property or application.

The Modernization Plan can categorize each property, or, application into one of three primary categories. The first is “No Action Required”. This category is used to indicate that no actions are planned for this property, or application and that a conscious decision has been made to continue to accept any associated “risks” identified thru “Health” Check and Technical Maturity evaluation process. The second is “Retire/Migrate”. This category is used to indicate that a decision has been made automatically or by management to “retire” the property or application. If the functionality of the property or application is no longer needed, it can simply be eliminated. If the functionality is still needed but the existing property or application is not the proper tool, then the organization or business can “migrate” to another solution. The third is “Modify/Replace”. This category is used to indicate that the decision has been made automatically or by management to “modify” the existing application or “replace” it with a different solution.

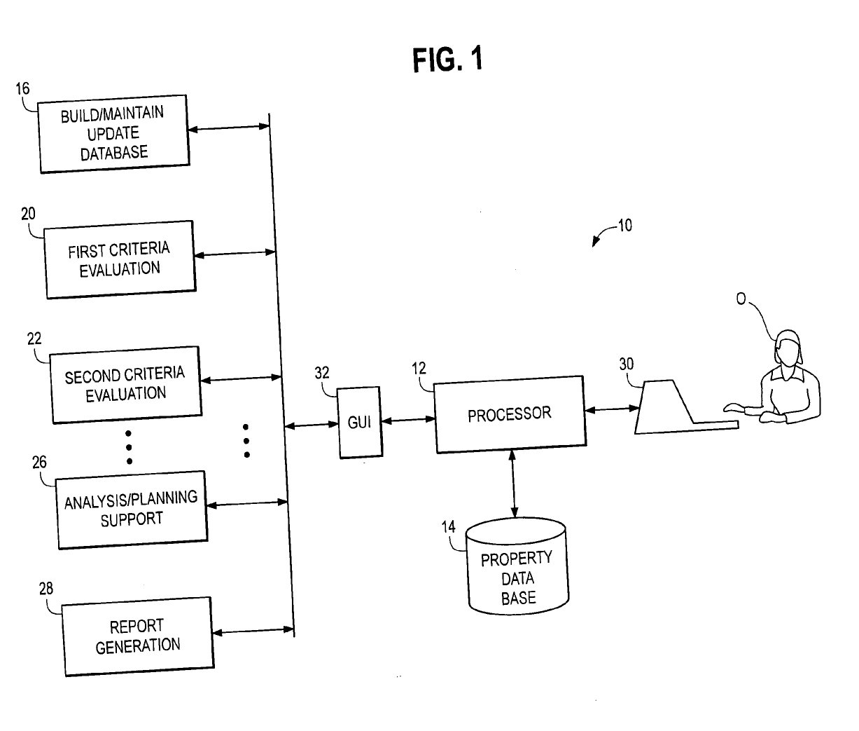

FIG. 1 is a block diagram of a hardware/software system 10 in accordance with the invention. System 10 would incorporate one or more programmable processors 12. The processors 12 can be programmed by a plurality of software modules or systems, some of which are illustrated in FIG. 1. It will be understood that processor(s) 12 might also access a computer network and could be physically dispersed.

Processor 12 communicates with a properties/application database 14 which could be implemented as a relational database of the type known to those of skill in the art. It will be understood that the exact implementation details of the database 14 are not a limitation of the invention.

As shown in FIGS. 1,2 software associated with the system 10 includes one or more modules 16 used to build, maintain and update database 14. One or more properties in the properties database 14 can be evaluated in accordance with first criteria by module or modules 20. The same set of properties can be evaluated in accordance with second criteria by module or modules 22. Results of the first and second evaluations by modules 20, 22 can provide an assessment of enterprise risk associated with the evaluated set of properties. These assessments, in accordance with the first and second criteria, and in response to selection of the set of properties from the database 14, can be automatically produced for management's decision making concerning risk. Results of those assessments can be coupled to and stored in the database 14.

System 10 also enables management, through an interactive process, to develop one or more plans for modification or mitigation of those risks identified by the prior evaluations, module or modules 26. A variety of reports can be produced for enterprise management using the report generation software 28. An operator O can communicate with the system 10 via a graphical display 30 and graphical user interface software 32.

By way of example and not limitation, operator O, via graphical user interface software 32 can select a group of properties to be evaluated, and carry out the evaluation processes in accordance with the first and second criteria, modules 20, 22. Subsequently, the operator O can make use of available planning and support software 26 to evolve a plan for risk mitigation.

It will be understood that system 10 can be used to evaluate property portfolios without limitation. For purposes of disclosing the best mode of practicing the invention and describing the invention in the following discussion, the property portfolio corresponds to a plurality of software modules, application programs, programming systems and the like, that an enterprise might own or have rights therein, which are used in the normal course of the enterprise's business. It will also be understood that modules 16, 20, 22, 26, 28 and 32 of the system 10 could be implemented with a variety of programming languages without departing from the spirit and scope of the invention. They could also be disbursed to a plurality of physical sites and communicate via computer network(s).

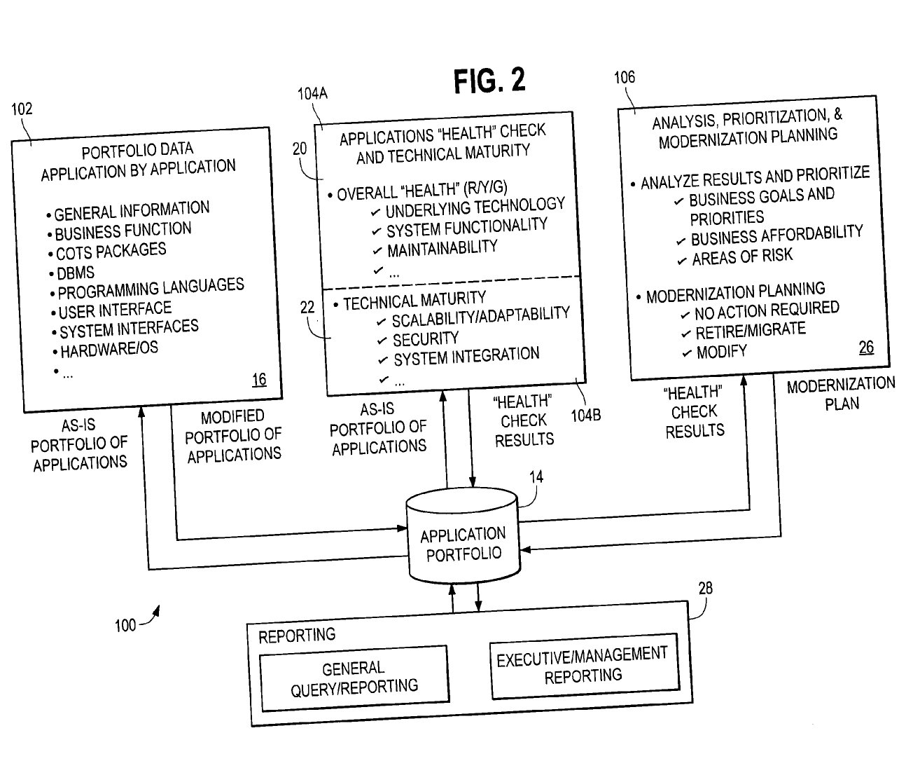

FIG. 2 illustrates an overall process 100 in accordance with the invention. The database 14 is initially populated with information associated with the properties in the application portfolio, such as application programs or software, step 102, using for example software modules 16. Representative information associated with the properties in the application portfolio includes without limitation, application name, ownership information, status, application architecture information, go live date, planned retirement date, disaster recovery information, type of application and additional information of a type that would be understood by those of skill in the art which would be useful in characterizing or identifying the respective software properties.

Where the database 14 has been appropriate populated with information pertaining to the various software properties of interest to the enterprise, including those it may own, those it has licenses under, those it receives services from which might be the property of third party service providers, and the like, the operator O can then specify a set of those properties of interest, via the graphical user interface 32. It will be understood that the exact details of specification of a set of software properties are not limitations of the present invention.

In response to the Operator O having specified an appropriate set of properties, in step 104a those properties of the selected set are evaluated by software module 20 in accordance with the first criteria. Where the properties correspond to software or applications, the “health” of members of the selected plurality is evaluated by module 20, in accordance with predetermined criteria.

Subsequently, step 104B, the members of the selected set of properties are evaluated in accordance with second predetermined criteria, modules 22, to arrive at a determination of the potential risk associated with the various selected properties in accordance with a predetermined technology/maturity evaluation. Technical maturity criteria can include without limitation, scalability/adaptability issues, user interfaces, programming languages, documentation and data management considerations.

The results of the evaluations in accordance with the first criteria and second criteria for example, the health check and tactical maturity evaluation can be stored in the database 14 for subsequent use.

Results of the first and second evaluations can be provided to the operator O via the graphical user interface 32. Additionally, in a step 106, the results of the initial evaluations can be combined automatically or by management with business considerations, priorities, budgetary issues and risk considerations to interactively develop plans to modernize some or all of the selected properties in the set, so as to alter/reduce enterprise risk relative to the selected set of properties.

It will be understood that while first and second criteria are discussed subsequently, such discussions are exemplary in nature only and are not limitations of the present invention. Other criteria could be used as would be understood by those of skill in the art for different types of properties. Irrespective of the type of properties, one or more evaluation criteria can automatically be applied to same to arrive at evaluations of the selected portfolio which provide information to management to assess the risk/risks associated with various properties used by or relied on by the particular enterprise in carrying out its normal activities.

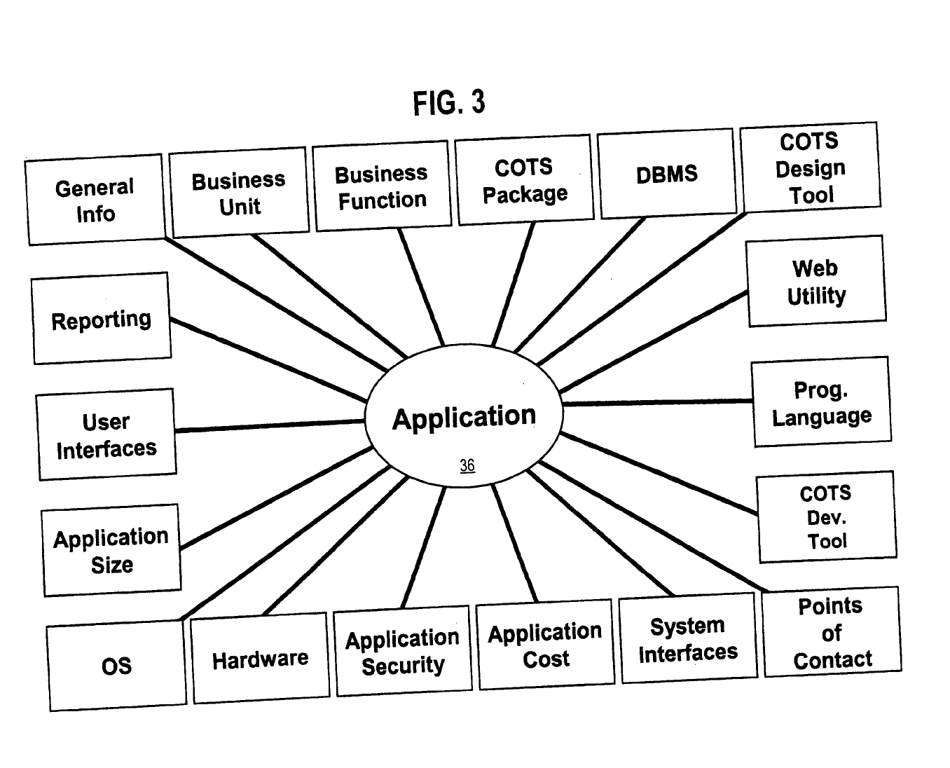

FIG. 3 illustrates schematically the type of information associated with a representative property, for example, a software application 36. Application 36 is one of the properties, for example, present in the application portfolio 14.

Table 1 is a representative enumeration of the type of information in the application database 14 which is associated with application 36. It will be understood that the types of information in Table 1 are exemplary only and not limitations of the invention. It will also be understood that details of the data structure(s) of database 14 are not limitations of the present invention.

TABLE 1

| General Information | Application Name |
|---|---|
| | Owning Business Unit |
| | Primary Support Provider |
| | Application Status |
| | Application Architecture |
| | Go Live Date |
| | Planned Retirement Date |
| | Disaster Recovery |
| | Application Type |
| | Average Number of Concurrent Users |
| | Total Number of Users |
| | Application Scope |
| | Web Enabled |
| | External Appliaction |
| | Application URL |
| | System Management Support |
| | Primary Programming Language |
| | Application Trend |
| | Business Criticality |
| | Data Retention Requirement |
| | Description |
| Organization or Business Unit | Business Unit(s) |
| | Location(s) |
| Business Function | Major Business Function(s) |
| | Business Sub Function(s) |
| Commercial Off the Shelf (COTS) | COTS Package(s) |
| Packages | Version(s) |
| DBMS | DBMS(s) |
| | Version(s) |
| COTS Design Tools | COTS Design Tool(s) |
| | Version(s) |
| Web Utilities | Web Utility(s) |
| | Version(s) |
| COTS Development Tools | COTS Development Tool(s) |
| | Version(s) |
| Programming Languages | |
| User Interface(s) | |
| Points of Contact | Employee Identifier(s) |
| | Contact Type(s) |
| System Interfaces | System Name/Acronym(s) |
| | Interface Name(s) |
| | Data Feed Direction(s) |
| | Data Feed Process Mode(s) |
| | Data Feed Frequency(s) |
| | Data Transport Protocol(s) |
| | Interface Complexity(s) |
| | Interface Architecture(s) |
| | Interface API(s) |
| | Data Structure(s) |
| | Interface Description(s) |
| Application Cost | Year(s) |
| | Recurring Hardware Cost(s) |
| | Recurring Labor Cost(s) |
| | Recurring Software Cost(s) |
| | Recurring Mainframe Cost(s) |
| | Nonrecurring Hardware Cost(s) |
| | Nonrecurring Labor Cost(s) |
| | Nonrecurring Software Cost(s) |
| Application Security | Login Type |
| | Login Method |
| | Other Factor Authentication |
| | Social Security for UID |
| | Network Visibility |
| | Database Calls Used |
| | Secondary Login |
| | Authentication |
| | Task Level Authorization |
| Hardware | Location(s) |
| | Type(s) |
| | Description(s) |
| | Model Number(s) |
| | Server/Machine Name(s) |
| | Environment(s) |
| OS | OS(s) |
| | Version(s) |
| Application Size | Year(s) |
| | Size Quantity(s) |
| | Size Unit of Measure(s) |
| | DB Size(s) |
| | Trend Description(s) |
| | Trend Analysis(s) |
| Reports | Aging Application Timeline |
| | Summary |
| | Business Area Summary |
| | DBMS Summary |
| | Functional Area Summary |
| | Ad-Hoc Queries |

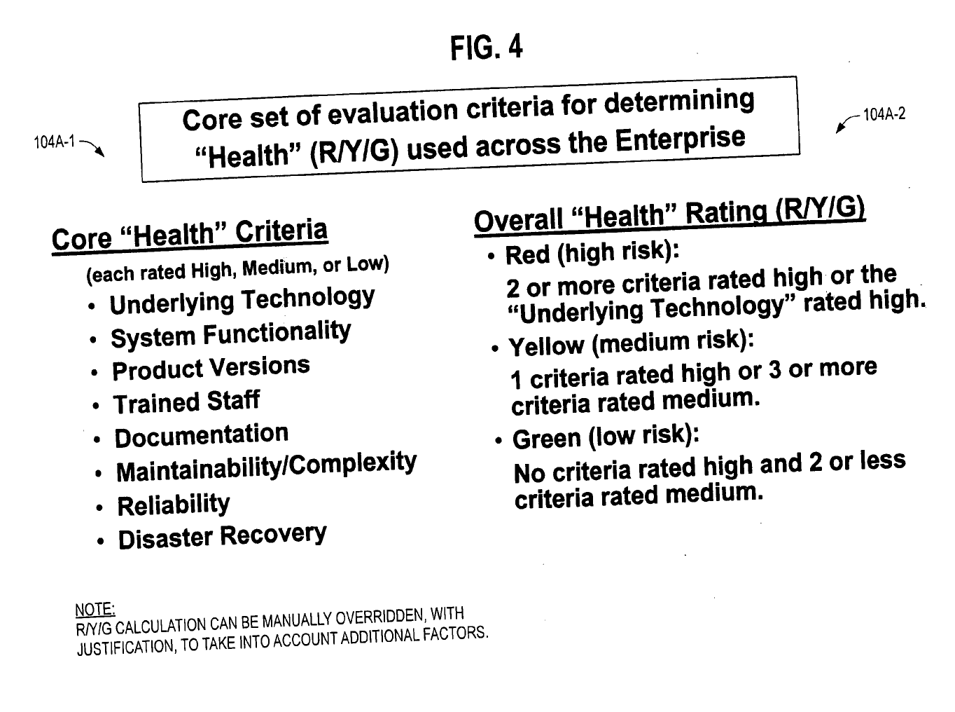

FIG. 4 provides additional information as to the first criteria, implemented via module or modules 20 for purposes of carrying out a “health” evaluation of the respective software properties or applications selected from the property database 14. This evaluation is based on the types of information per property of FIGS. 2,3 and Table 1, and can be based on some of the criteria listed in FIG. 4 without limitation.

The results of the first criteria evaluation step 104A-1 (FIGS. 2,4), produce a risk rating of high, medium or low which can be represented in a color coded form, reflective of high risk, medium risk and low risk, step 104A-2 (FIG. 4). It will also be understood that various schemes can be used to assign risk indicia within the spirit and scope of the invention.

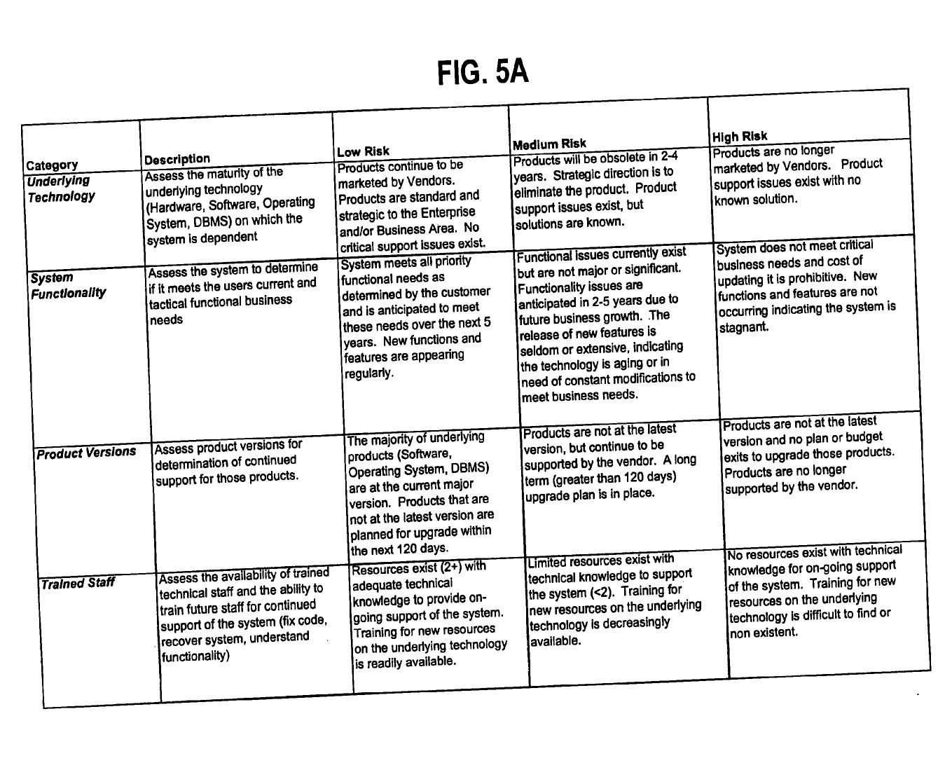

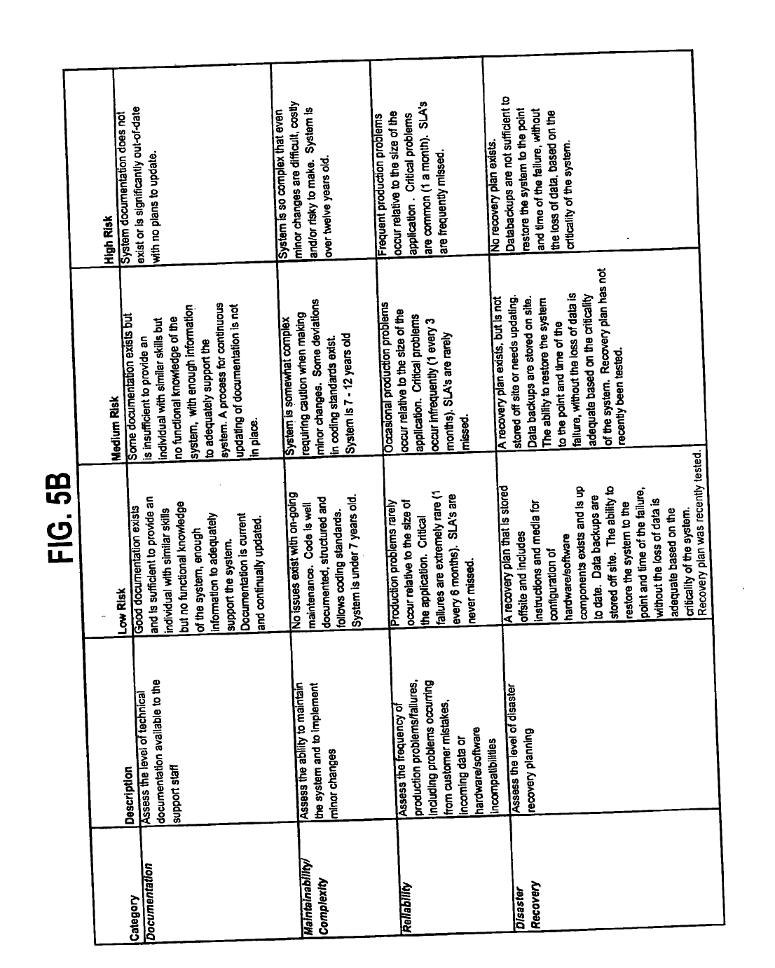

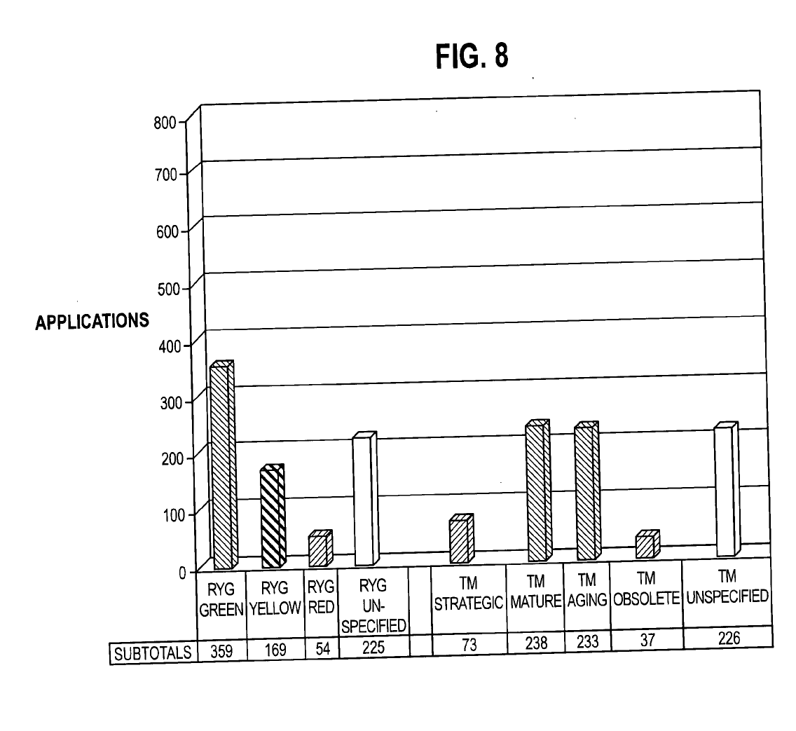

FIGS. 5A-5B provide additional details as to how each of the informational aspects of the property or application present in the database 14, see FIG. 3 and Table 1, can be evaluated so as to determine a multi-level “health” related risk rating, step 104A-2 (FIG. 4). Using the process categories of FIGS. 5A, 5B, an overall risk rating associated with health of the particular software module or application as in step 104A-2 can then be determined. As discussed subsequently, this risk profile either on a per property basis or on a set of properties basis can be presented either numerically or graphically via the graphical user interface 32 to operator O, best seen in FIG. 8.

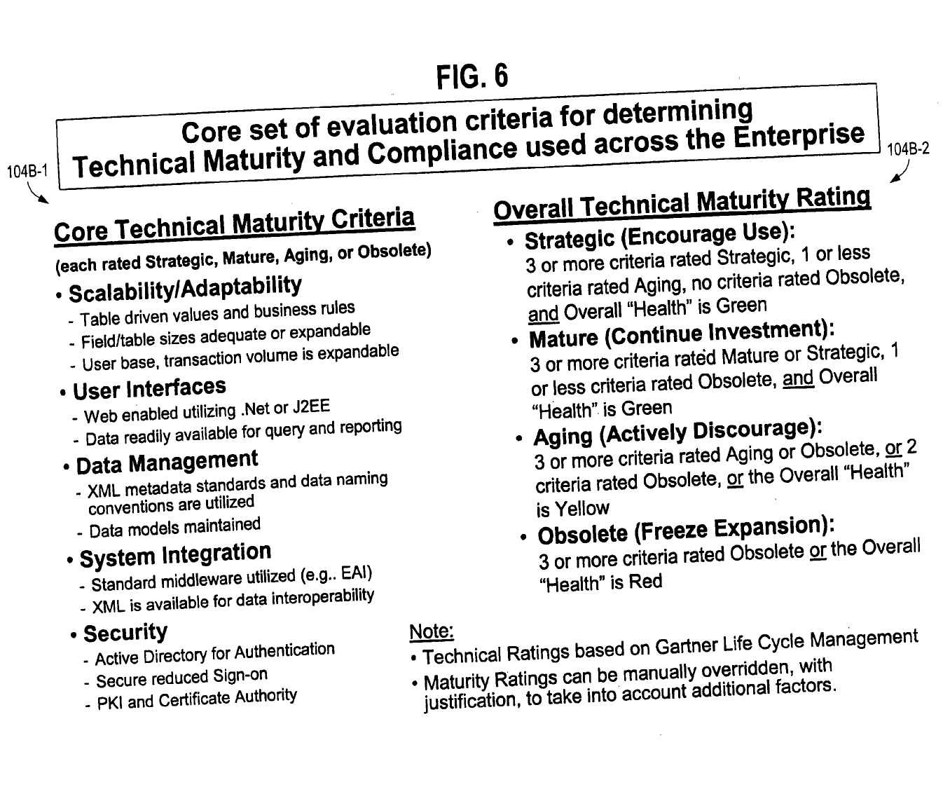

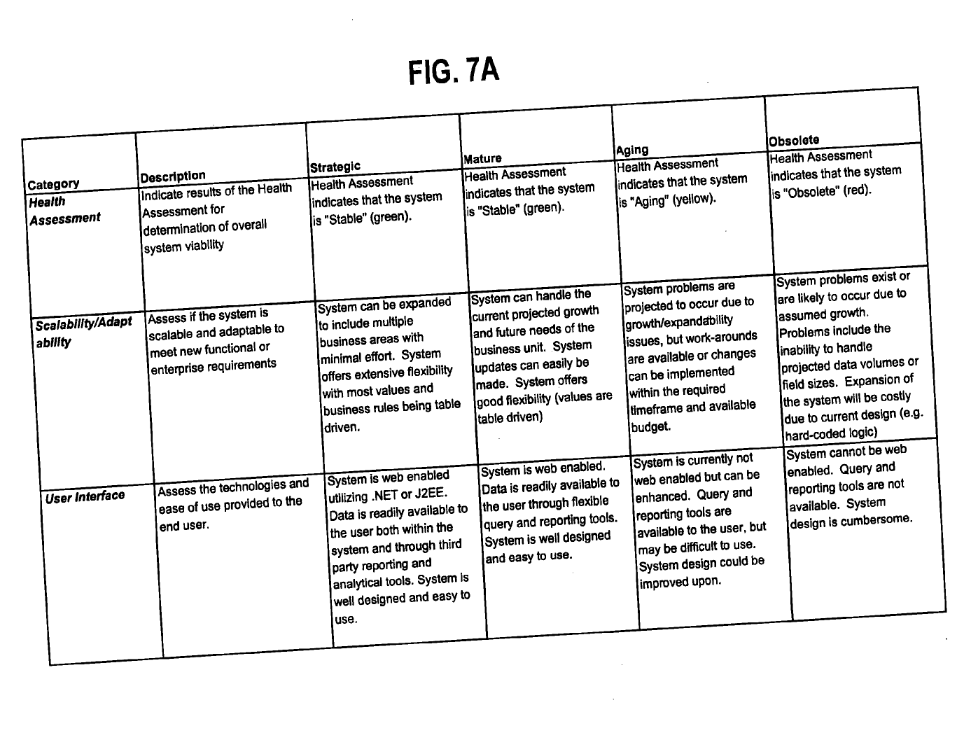

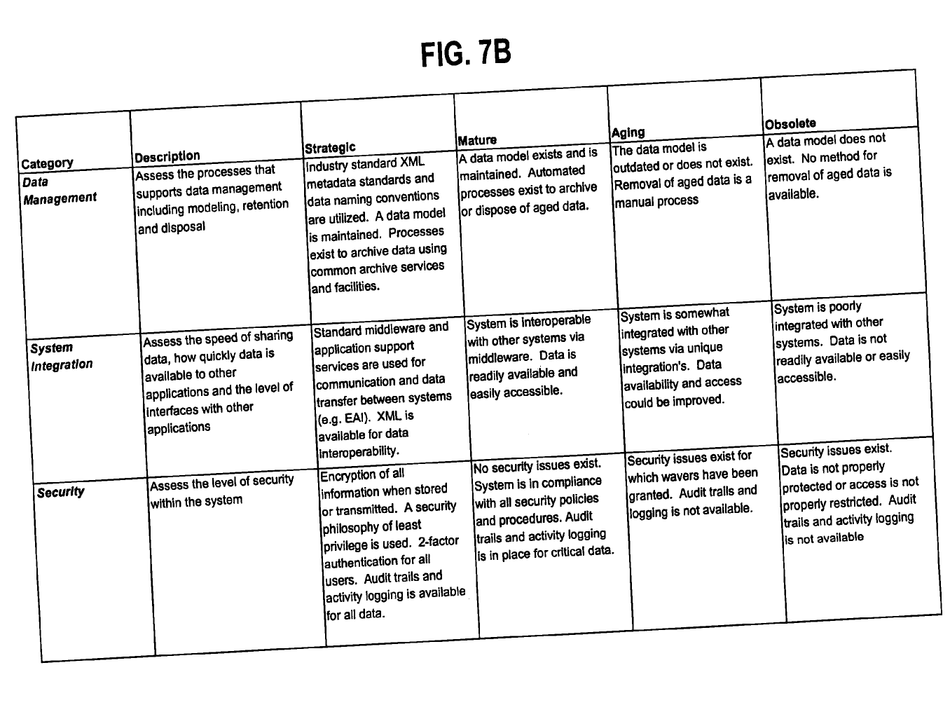

FIG. 6 illustrates process step 104B of carrying out the second criteria evaluation, module or modules 22, from the point of view of “technical maturity” of one or more software properties. As illustrated in step 104B-1, data present in property database 14 for each member of a selected set, is evaluated in accordance with a plurality of selected factual elements indicative of technical maturity. In step 104B-2, the results of the evaluation produce a multi-pronged rating such as strategic, mature, aging and obsolete. FIGS. 7A and 7B provide additional process details as to how factual information associated with the selected property in the set of properties is evaluated so as to arrive at the technical maturity rating step 104B-2. It will be understood that other criteria could be defined for carrying out such evaluations based on different data for the specified property or properties all without departing from the spirit and scope of the invention.

The results of the evaluations based on the first and second criteria can be presented graphically to the operator O using graphical user interface 32, best seen in assessment screen, FIG. 8. The assessment screen of FIG. 8 provides to operator O and enterprise management a clear indication of risks associated with a set of specified properties based on the health and maturity (first and second) criteria of FIGS. 4 and 6. In the example illustrated in FIG. 8, numerous properties, which could be application programs relied on by the enterprise, have been given a “green” health rating. However, other significant numbers of such properties have been given a “yellow” or a “red” health rating. Further, the same set of properties also reflects a predominantly mature/aging condition which may be undesirable to management.

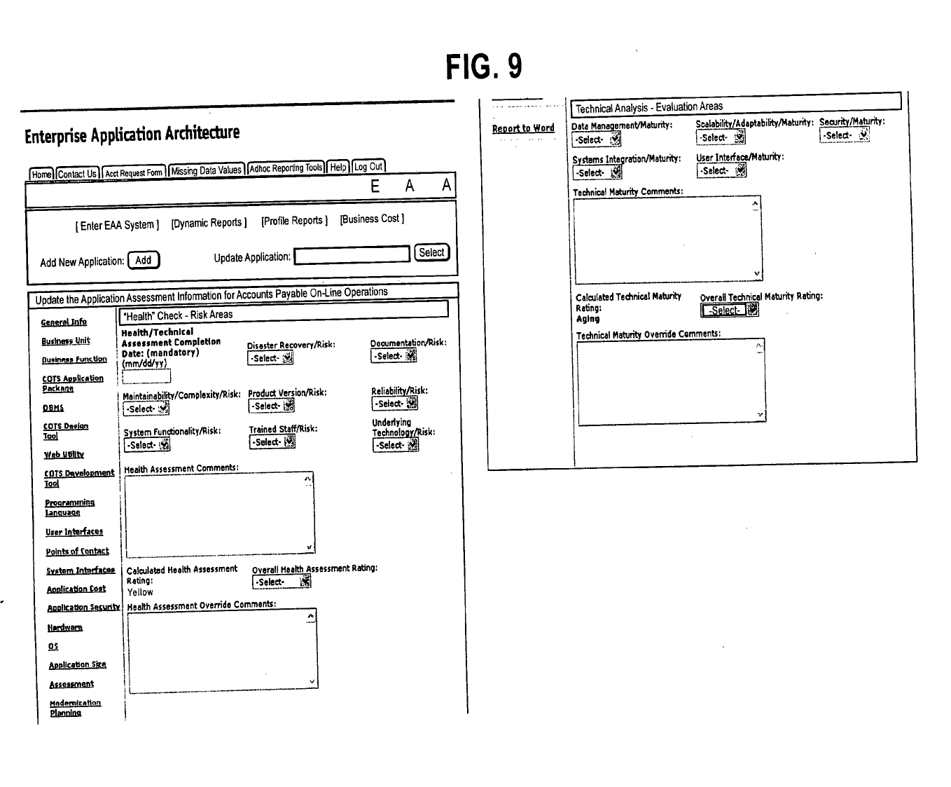

FIG. 9 is a representative screen presentable on display 30 by graphical user interface 32 which presents the type of information of FIG. 8 in a non-graphical format. The screen of FIG. 9 enables the input or display of “Health” Check and Technical Maturity evaluation results within the database 14. The analyst responsible for a specific application could use methods described above to assess the application and record the results within the portfolio 14.

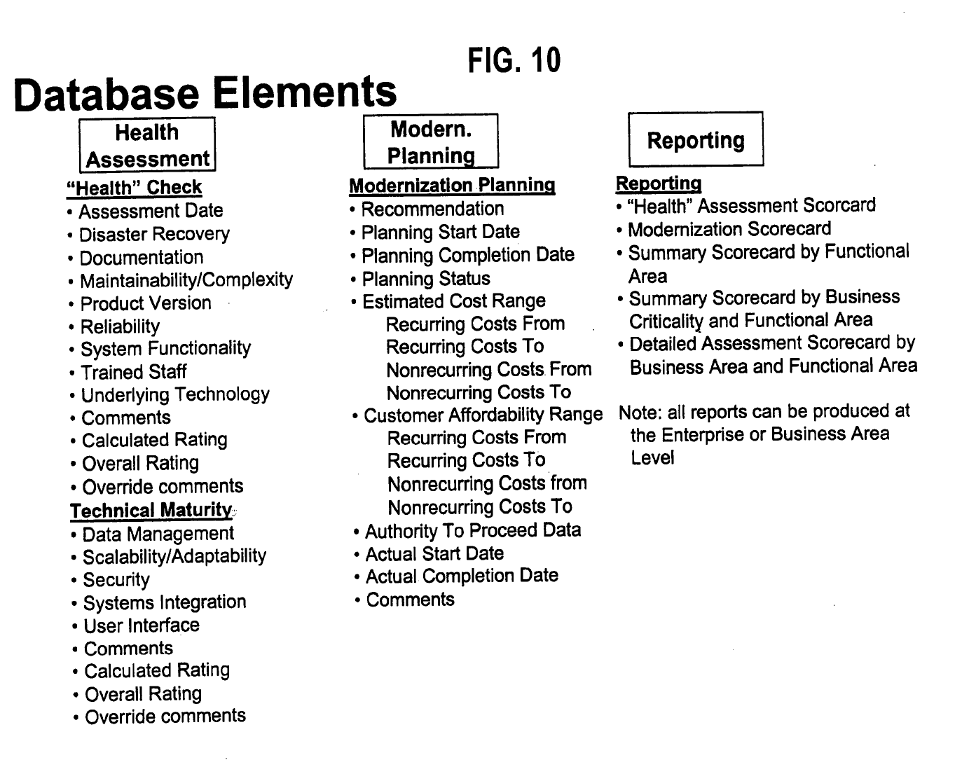

FIG. 10 illustrates available contents of the database 14 as a result of the evaluations 104 and further analysis and modernization plan step 106. The information obtained and the risk assessments arrived at, steps 104A, 104B can be used by operators such as the operator O to develop risk mitigation or risk reduction plans which could include developing recommendations to replace, update or modify various members of the set of properties. Information can include project start and completion dates, cost estimates, customer affordability information and the like.

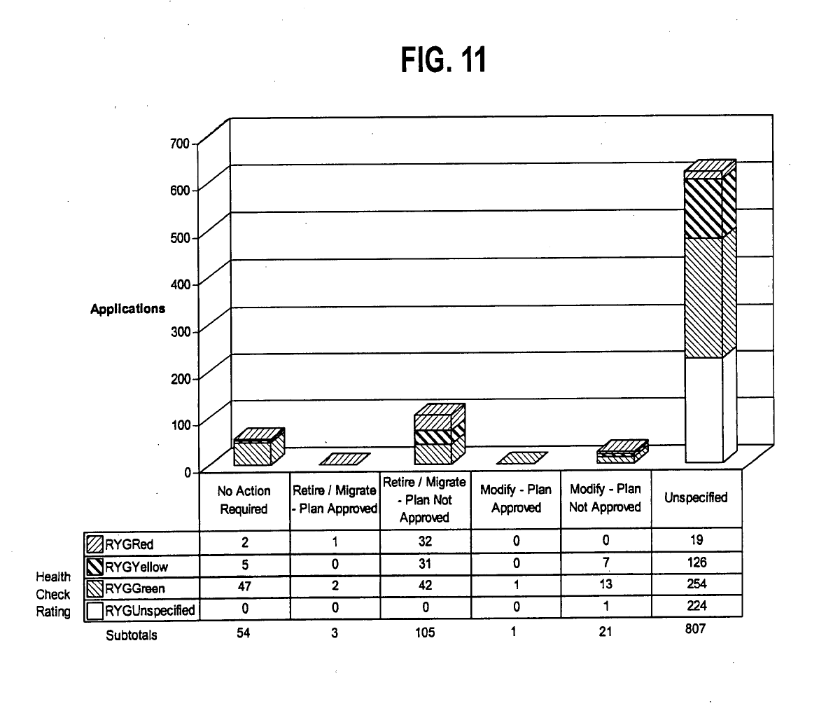

A proposed plan could be presented graphically using display 30 and graphical user interface 32 as illustrated in FIG. 11. The screen of FIG. 11 identifies a plurality of properties, some of which in fact are high risk properties where no action is to be taken. It also identifies a group of properties to the retired or mitigated. Finally, it identifies a plurality of properties to be modified in accordance with proposed risk alteration plans.

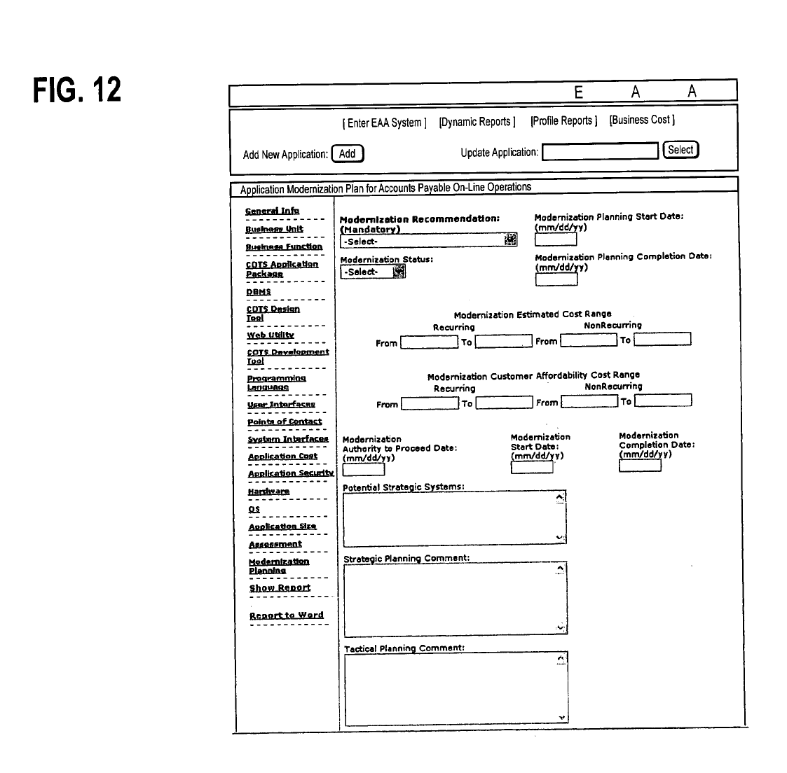

Similar types of information can be presented in a non-graphical fashion as on the screen of FIG. 12. The screen of FIG. 12 can be used to store or display the modernization results within the database 14. The analyst responsible for an application could use methods described above to assess the application and record the results within the portfolio 14.

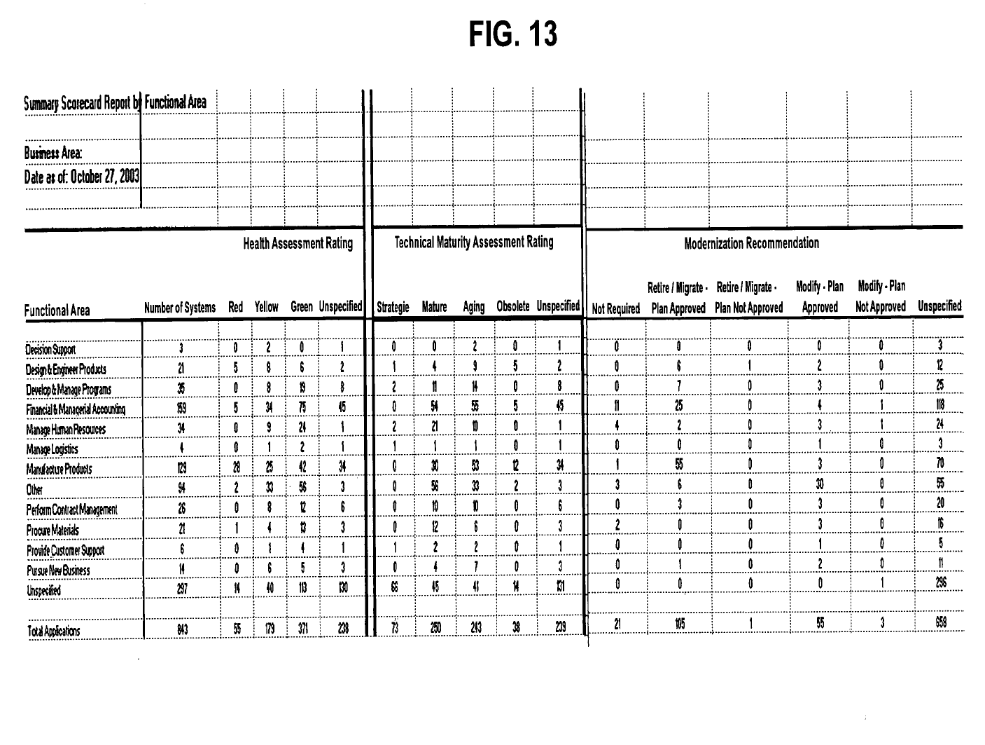

The system 10 can also provide various types of reports. A page of a representative report illustrated in FIG. 13, can be presented on display 30. The image of FIG. 13 is a sample report which illustrates the results of the prior evaluations, step 104A, B as well as the modernization recommendations, step 106, by functional area within the enterprise. The report of screen 13 is at a lower level than the global view of the proposed modernization plan of FIG. 1I.

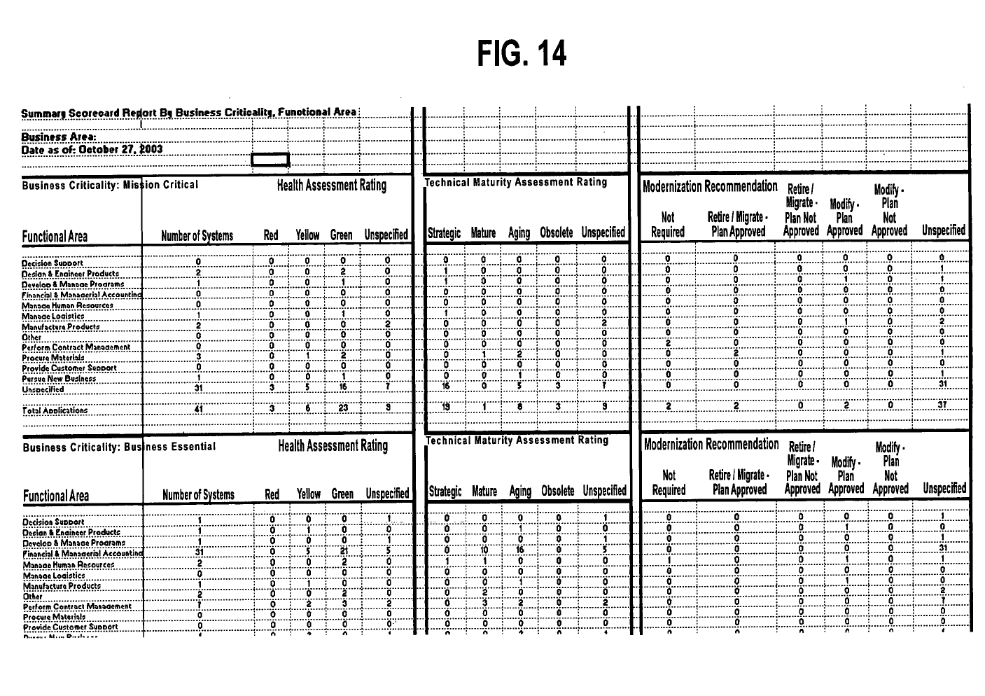

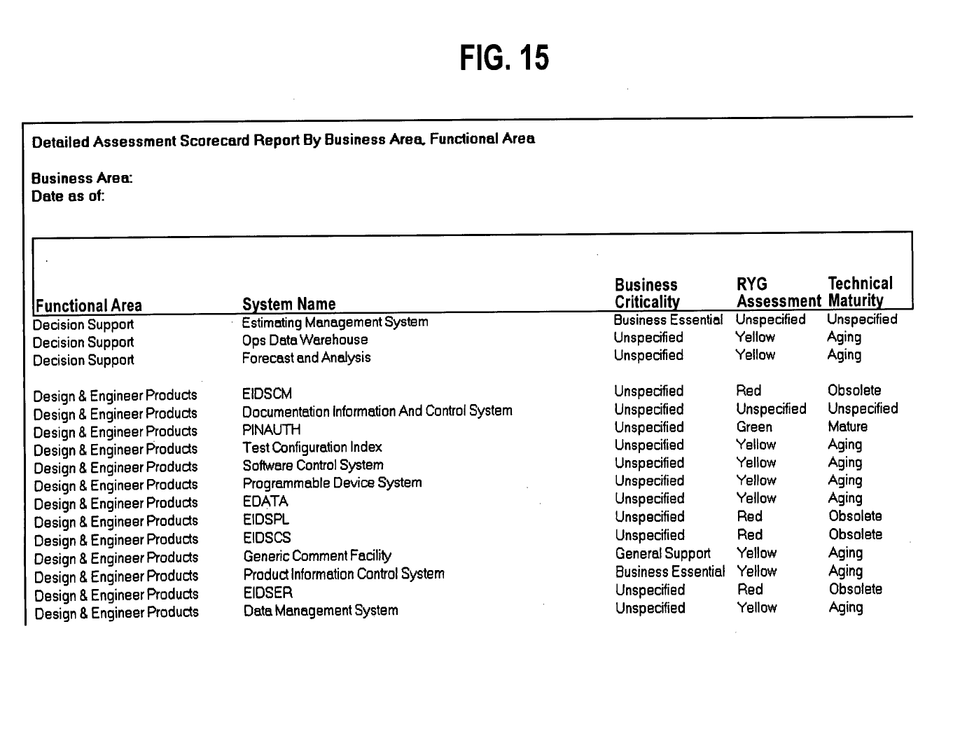

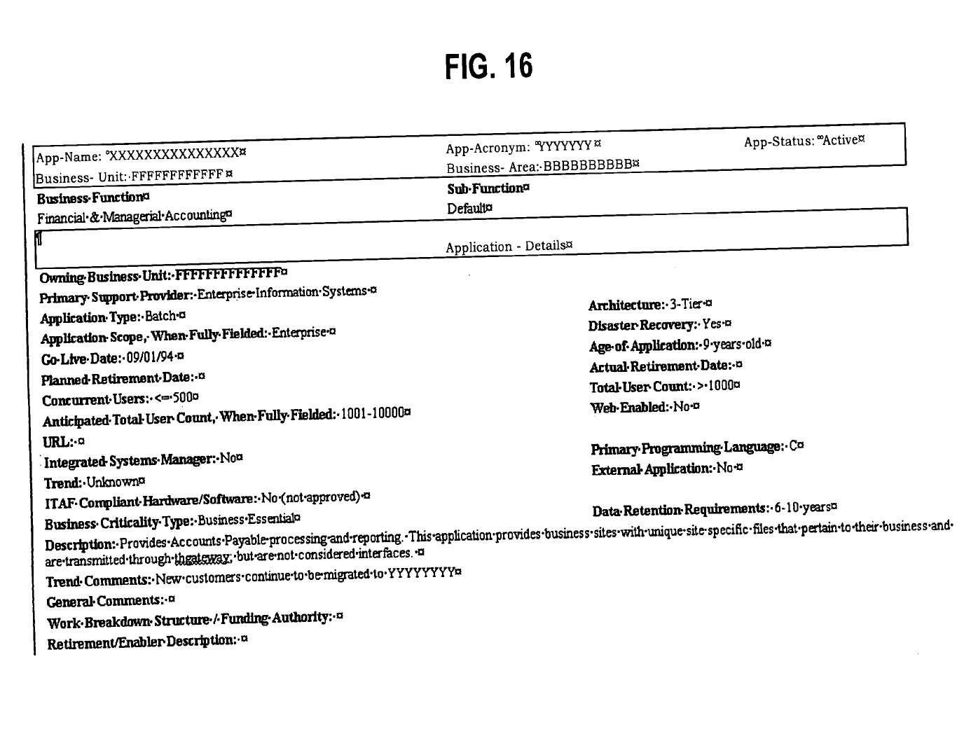

The next level report FIG. 14 can present information by each criticality of the particular property or properties. Within each criticality information about the particular property or properties, is presented by function. Where the report of FIG. 14 identifies potential areas of concern for management, a lower level report, FIG. 15 can be produced and presented which is directed to a selected property or application. Finally, the screen of FIG. 16 can be presented which includes all of the information within the property portfolio and database 14 concerning the selected property.

It will be understood that the above described reports and the types of information contained therein are exemplary only and not limitations of the present invention. Other types of reports and information can be presented within the spirit and scope of the invention.

Those of skill in the art will understand that evaluations and determinations as above can be carried out in accordance with predetermined criteria if desired without departing from the spirit and scope of the invention. Alternately, three or more different criteria could be used also without departing from the spirit and scope of the invention.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modification as fall with the scope of the claims.

1. An evaluation system comprising:
a database of enterprise related information;
query software for presenting an informational inquiry to the database; and
evaluation software, responsive to a presented inquiry which evaluates information in the database in accordance with predetermined criteria.

2. A system as in claim 1 where the evaluation software includes at least first and second evaluation software, where the criteria include at least first and second different respective criteria and where information in the database is evaluated in accordance with the first and second criteria.

3. A system as in claim 2 where the first criteria include a first set of multiple parameters associated with information in the database.

4. A system as in claim 3 where the enterprise related information comprises a set of computer programs.

5. A system as in claim 4 where the first set of parameters comprises parameters indicative of at least one of program technology, program functionality, program maintainability program support, availability of trained support staff, documentation, program reliability, or disaster recovery.

6. A system as in claim 5 where the first software evaluates the set of computer programs using the first set of parameters.

7. A system as in claim 6 where multi-element rating designations are applied to the results of the evaluation by the first software.

8. A system as in claim 2 where the second criteria include a second set of multiple parameters associated with information in the database.

9. A system as in claim 8 where the enterprise related information comprises a set of computer programs.

10. A system as in claim 9 where the second set of parameters comprises parameters indicative of at least one of program health, program adaptability, characteristics of user interface, assessment of data management characteristics, program security, or program integration.

11. A system as in claim 10 where the second software evaluates the set of computer programs using the second set of parameters.

12. A system as in claim 11 where multi-element rating designations are applied to the results of the evaluation by the second software.

13. A system as in claim 2 which includes third evaluation criteria.

14. A system as in claim 1 where the information in the database pertains to a plurality of programs and the software evaluates at least some of the programs in accordance with the predetermined criteria.

15. A system as in claim 2 where the information in the database pertains to a plurality of programs and the first and second software evaluate at least some of the programs in accordance with the first and second criteria.

16. A system as in claim 1 where the database comprises a relational database which incorporates enterprise related information and selected linkages therebetween.

17. A system as in claim 2 where the first criteria relate to at least one of program health, technology, program functionality or program maintainability.

18. A system as in claim 17 where the second criteria relate to at least one of program maturity, program adaptability, program security, program integration.

19. A system as in claim 17 which develops a risk profile relative to at least the first criteria.

20. A system as in claim 18 which develops first and second risk profiles relative to at least the first and second criteria.

21. A system as in claim 20 which in response to at least another inquiry presents a risk modifying plan.

22. A system as in claim 2 which includes third software for specifying a set of enterprise related properties in the database.

23. A system as in claim 22 where the first software evaluates the set of properties in accordance with the first criteria.

24. A system as in claim 23 which includes fourth software to apply multi-level ratings to the results of the evaluation by the first software.

25. A system as in claim 22 where the second software evaluates the set of properties in accordance with the second criteria.

26. A system as in claim 25 which includes fourth software to apply multi-level ratings to the results of the evaluation by the second software.

27. Enterprise evaluation software recorded on at least one computer readable medium comprising:
first software that evaluates enterprise assets in accordance with a first criteria; and
second software that evaluates those assets in accordance with a second, different, criteria.

28. Software as in claim 27 which provides evaluation results in accordance with at least one pre-established parameter.

29. Software as in claim 28 where the first software evaluates assets in accordance with at least one of underlying technology, asset functionality or asset maintainability.

30. Software as in claim 28 where the second software evaluates assets in accordance with at least one of asset health, asset scalability, asset adaptability, asset security, or integration.

31. Software as in claim 28 which includes third software to access a pre-established database.

32. Software as in claim 31 which includes graphical user interface software to enter queries relative to data in the database.

33. Software as in claim 29 where the second software evaluates assets in accordance with at least one of asset maturity, asset scalability, asset adaptability, asset security, or integration.

34. Software as in claim 33 which includes additional software, responsive to the evaluations, to present the evaluated assets in accordance with a third criteria.

35. Software as in claim 2 where the assets comprise computer programs, the first criteria corresponds to program condition and the second criteria corresponds to program maturity.

36. Software as in claim 35 which includes a third criterion which corresponds to risk.

37. A method comprising:
selecting a set of assets;
automatically evaluating the assets in accordance with first criteria; and
automatically evaluating the assets in accordance with second, different, criteria.

38. A method as in claim 37 which includes, in response to the results of the evaluations, establishing the relationship of the members of the set of assets to at least one selected category.

39. A method as in claim 38 where the establishing includes evaluating risks associated with members of the set of assets.

40. A method as in claim 38 where the members of the set of assets are associated with one of a plurality of ratings in response to the evaluations.

41. A method as in claim 37 which includes establishing multi-factor first criteria for automatically evaluating the assets.

42. A method as in claim 41 which includes assigning one of a plurality of ratings to assets of the set in response to automatically evaluating in response to the first criteria.

43. A method as in claim 42 which includes establishing multi-factor second criteria for automatically evaluating the assets.

44. A method as in claim 43 which includes assigning one of a plurality of ratings to assets of the set in response to automatically evaluating in response to the second criteria.
